(19) United States
(12) Patent Application Publication
(10) Pub. No.: US 2009/0135327 A1
(43) Pub. Date: May 28, 2009

(54) LIQUID CRYSTAL DISPLAY DEVICE AND MANUFACTURING METHOD OF LIQUID CRYSTAL DISPLAY DEVICE

(75) Inventor: Kenichi MINOWA, Kumamoto (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/272,270

(22) Filed: Nov. 17, 2008

(30) Foreign Application Priority Data
Nov. 22, 2007 (JP) 2007-302395

(51) Int. Cl. G02F 1/133

(52) U.S. Cl. 349/54; 349/192

(57) ABSTRACT

The current invention aims at obtaining a liquid crystal display device in which a yield is enhanced and a representation quality is enhanced by repairing a wiring defect due to broken wiring recognized by representation inspection after a CF is bonded and turning a luminescent spot defect into an unnoticeable black spot defect without introduction of an inspection device in a state of a TFT substrate, without any extra cost. The liquid crystal display device of the current invention in which a liquid crystal is interposed between first and second substrates, and the first substrate is a substrate of an active matrix structure comprising a thin film transistor and the second substrate is a substrate comprising a color filter, a projecting portion which is disposed in a predetermined area of the color filter and a conductive film formed on a front end.

### BACKGROUND OF THE INVENTION

1. Field of the Invention

The present invention relates to an active matrix type liquid crystal display device, which is driven by a thin film transistor formed on a glass substrate, and a manufacturing method thereof.

2. Description of the Background Art

Conventionally, as an active matrix type liquid crystal display device, there has been known a liquid crystal display device having an IPS drive system in which a direction of electric field applied to the liquid crystal is set parallel to a substrate. This liquid crystal display device has a pair of substrates opposed to each other, and a gap between the substrates is kept constant with a spacer while the gap between the substrates is filled with liquid crystal. A substrate thereof is an active matrix type substrate in which a thin film transistor (TFT) is formed (hereinafter referred to as TFT substrate) and includes a gate wiring and a source wiring which intersect each other and a comb-like drain wirings constituted of a plurality of wirings provided parallel to the source wiring. The drain wirings and common wirings are formed on the same TFT substrate alternately and parallel to each other and drive of the liquid crystal is controlled by charges accumulated between conductors of the drain wiring and the common wiring. As a conductive film, generally, a transparent electrode such as ITO and IZO is used. The opposed substrate has a color filter (hereinafter described as CF substrate) and a black matrix which shield a domain region of the liquid crystal, color material layer, organic film layer and column spacer are formed. Usually, no conductive film is formed on the CF substrate.

However, even in the liquid crystal display device formed in such a way, representation error due to breaking of wiring, luminescent spot defect or the like can occur. A liquid crystal display device capable of repairinging a defect point with laser processing even if the source wiring of the TFT substrate is broken has been disclosed in Japanese Patent Application Laid-Open No. 2003-307748. According to this liquid crystal display device, if the source wiring is broken within a source wiring display region, the common wiring which can be used for charge auxiliary capacity is used as a graft so as to turn a portion in which the source wiring is broken into a conductive state through the common wiring.

As regards the luminescent spot defect, Japanese Patent Application Laid-Open No. 2003-202581 has disclosed a liquid crystal display device in which the defect portion is repaired by laser processing. According to this liquid crystal display device, the drain portion and the common wiring used for charge auxiliary capacity are made conductive with each other by laser irradiation so as to turn that pixel into a black spot which is always displayed in an unnoticeable black at any time.

The repair methods described in Japanese Patent Application Laid-Open No. 2003-307748 and Japanese Patent Application Laid-Open No. 2003-202581 have a problem that the repair needs to be carried out prior to bonding the CF substrate. Further, it is not easy to find out the defect portion by man's observation with a microscope and it is difficult to find out the defect portion unless a conduction test or pixel processing test is carried out. Additionally, there is another problem that if such inspection devices are introduced, manufacturing cost is increased. In addition, there is also a problem that when a foreign matter enters the interior of a panel after the filter is bonded and then the defect is generated, this defect cannot be repaired.

### SUMMARY OF THE INVENTION

An object of the present invention is to provide a liquid crystal display device in which a yield and a representation quality are enhanced by repairing a wiring defect due to broken wiring recognized by representation inspection after a CF is bonded and turning a luminescent spot defect recognized by representation inspection after a CF is bonded into an unnoticeable black spot defect, and enabling reduction of cost.

The liquid crystal display device includes first and second substrates so as to interpose a liquid crystal. The first substrate is a substrate of an active matrix structure comprising a thin film transistor. The second substrate is a substrate comprising a color filter, a projecting portion which is disposed in a predetermined area of the color filter and a conductive film formed on a front end of said projecting portion.

The present invention makes it possible to obtain a liquid crystal display device which enables the defect recognized by representation inspection after a CF substrate is bonded to be repaired without executing any inspection in a state of the TFT substrate, so that the yield can be further enhanced and the representation quality can be enhanced without any extra cost.

A method of manufacturing the liquid crystal display device includes the following steps (a) and (b).

A step (a) is to prepare a liquid crystal display device in which a liquid crystal is interposed between first and second substrates, wherein the first substrate is a substrate of an active matrix structure comprising a thin film transistor and the second substrate is a substrate including a color filter, a projecting portion which is disposed in a predetermined area of the color filter and a conductive film formed on a front end of said projection portion.

A step (b) is to irradiate the projecting portion with laser beam from the first substrate side of the liquid crystal display device so as to make a wiring on the first substrate and the projecting portion conductive with each other at a position irradiated with the laser beam.

The present invention makes it possible to obtain a liquid crystal display device which enables the defect recognized by representation inspection after a CF substrate is bonded to be repaired without executing any inspection in the state of the TFT substrate, so that the yield can be further enhanced and the representation quality can be enhanced without any extra cost.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a structure of a TFT substrate of a liquid crystal display device of the present invention;

FIG. 2 is a view showing a structure of a CF substrate of the liquid crystal display device of the present invention;

FIG. 3 is a sectional view of the CF substrate of the liquid crystal display device of the present invention;

FIG. 4 is a sectional view showing a state in which the source wiring of the liquid crystal display device of the present invention is repaired; and

FIG. 5 is a sectional view showing a state in which a luminescent spot defect of the liquid crystal display device of the present invention is repaired.

### DESCRIPTION OF THE PREFERRED EMBODIMENTS

### First Embodiment

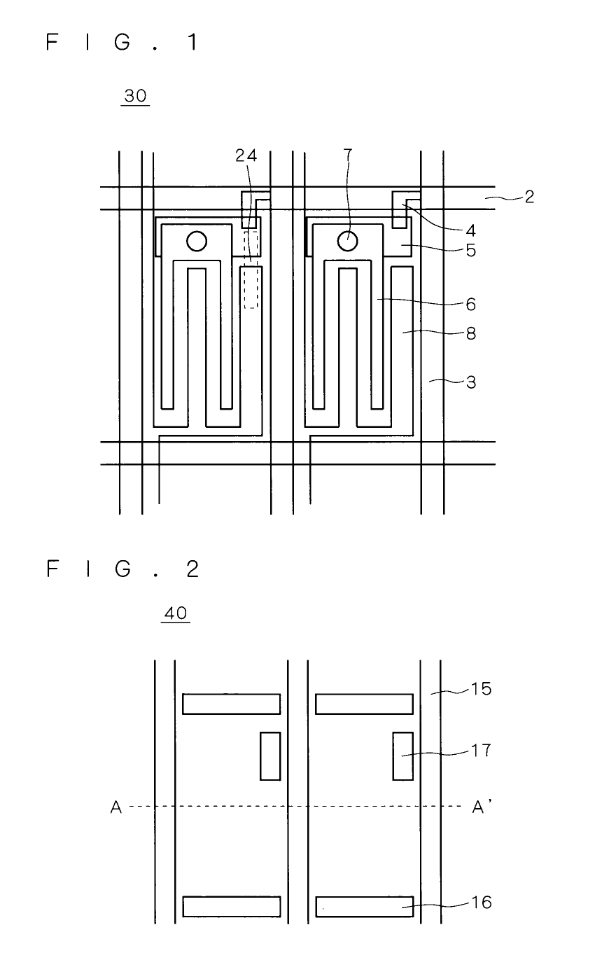

FIG. 1 is a view showing a structure of a TFT substrate 30 of a liquid crystal display device 1 of the present invention. According to this embodiment, the liquid crystal display device 1 is constructed in IPS drive system in which a direction of electric field to be applied to the liquid crystal is set parallel to the substrate. Plural parallel gate wirings 2 and source wirings 3 are formed on a TFT substrate 30 such that they intersect one another and a thin film transistor 4 (TFT) is connected at an intersecting portion as a switching device. The thin film transistor 4 is connected to a drain wiring 5. This drain wiring 5 is connected to a comb-like pixel wiring portion for plane drive (drain wiring 6) constituted of plural wirings provided parallel to the source wiring 3 with a contact portion 7. A comb-like common wiring 8 constituted of plural wirings disposed alternately with and parallel to the drain wiring 6 is formed on the topmost surface.

By applying a voltage between the drain wiring 6 and the common wiring 8, electric field substantially parallel to a substrate surface is applied to the liquid crystal layer so as to represent an image. A top surface of the source wiring 3, the gate wiring 2 and a luminescent spot repair portion 24 of drain side described later exist are covered with an insulation film 21 and an insulation film 22. Its topmost surface is so constructed that the conductive film of the common wiring 8 and the conductive film 14 of a projecting portion 13 make no contact with each other.

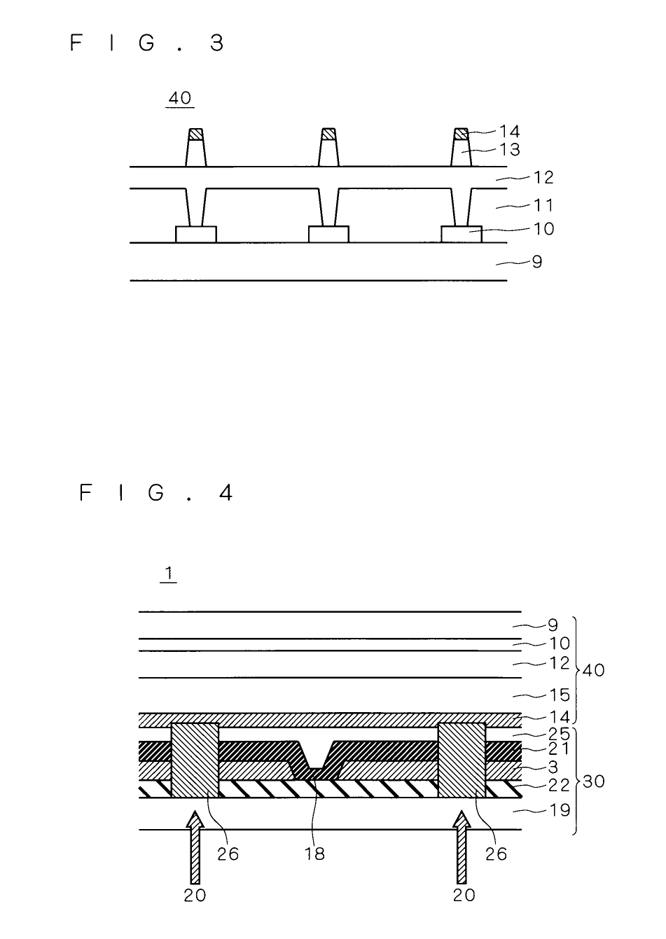

FIG. 2 is a view showing a structure of a CF substrate of the liquid crystal display device of the present invention. FIG. 3 is a sectional view taken along the lines A-A′ of this CF substrate 40. The CF substrate 40 includes a color filter 9, a black matrix 10 (hereinafter referred to as BM) which shields the domain region of the liquid crystal, a color material layer 11, an organic film layer 12, a projecting portion 13 and a conductive film 14 formed on a surface of the projecting portion 13.

This projecting portion 13 and the conductive film 14 form CF projecting portion for source portion repair 15, CF projecting portion for gate portion repair 16 and CF projecting portion for luminescent spot defect repair 17. The CF projecting portion for source portion repair 15 and the CF projecting portion for gate portion repair 16 serve as a bypass portion for repairing a wiring defect of the source wiring 3 and the gate wiring 2 and are formed in an area in which they overlap opposed a wiring portion of TFT substrate 30. The projecting portion 13 is formed in substantially the same shape (generally, rod-like) as the wiring and its front end is formed flat. As the material of the projecting portion 13, organic film of for example, acrylic resin is used and a mask pattern by photolithography is used for formation of a pattern. The conductive film 14 is formed on the flat front end portion of the projecting portion 13. The pattern of the conductive film 14 is formed by mask sputtering method using a mask for the conductive film pattern. As the material of the conductive film 14, metal such as Cr and Al or transparent electrode such as ITO, IZO is desirable.

The CF projecting portion for luminescent spot defect repair 17 serves as a bypass portion for repairing a luminescent spot defect and is formed in an area which extendedly overlaps opposed the drain wiring 5 and the common wiring 8 of the TFT substrate 30. The CF projecting portion for luminescent spot defect repair 17 is formed into a projecting shape and its front end is formed flat. A formation method for the CF projecting portion for luminescent spot defect repair 17 and a formation method for the conductive film 14 are the same as that of the above-described CF projecting portion for source portion repair 15 and CF projecting portion for gate portion repair 16.

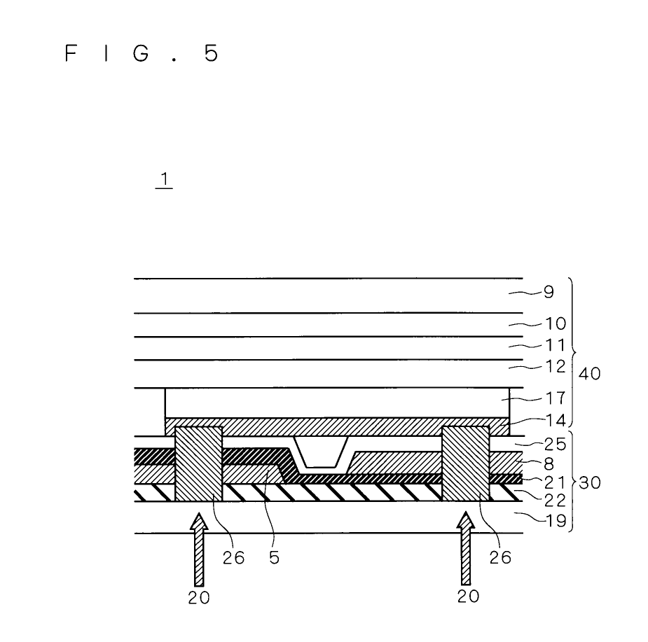

FIG. 4 is a sectional view showing a state in which the broken source wiring 3 of the liquid crystal display device 1 is repaired. A case where the source wiring 3 is broken will be described with reference to FIG. 4. If the liquid crystal display device 1 is formed and a wiring broken portion 18 is found in the source wiring 3, laser irradiation 20 is applied to two positions at the CF projecting portion for source portion repair 15 which extendedly opposed wiring broken portion 18 of the source wring 3 from the TFT glass substrate 19 side of the TFT substrate 30.

With this laser irradiation 20, a part of the insulation film 21 on the source wiring 3 formed on the TFT substrate 30 is destroyed. Consequently, the metal of the source wiring 3 is melted so as to form a laser irradiated connecting portion 26, in which the conductive material of the source wiring 3 is connected with the conductive film 14 at a front end of the CF projecting portion for source portion repair 15 of the CF substrate 40 by the laser irradiated connecting portion 26 through the destroyed portion of the insulation film 21. Therefore, the broken portion 18 of the TFT substrate 30 can secure conduction through the conductive film 14 on the CF substrate 40 side, whereby repairing the defect. Even if the gate wiring 2 is broken, that defect can be repaired by irradiating two positions with laser beam in the same way.

The wiring defect can be repaired by irradiating two positions of the CF projecting portion for source portion repair 15 or the CF projecting portion for gate portion repair 16, which are extended to the broken portion 18, with laser beam so as to form a new wiring bypass. Further, even if the wiring is broken due to entering of any foreign matter or scratch after the CF substrate 40 is bonded, the broken portion can be repaired.

By repairing the wiring defect due to a breaking of the wiring recognized in a representation inspection after the CF substrate is bonded without executing any inspection in the state of the TFT substrate 30, the liquid crystal display device 1 in which the yield is further enhanced and the representation quality is enhanced can be obtained without any extra cost.

FIG. 5 is a sectional view showing a state in which a luminescent spot defect of the liquid crystal display device is repaired. A case where a luminescent spot defect is generated will be described with reference to FIG. 5. If the liquid crystal display device 1 is formed and the luminescent spot defect is found out by representation inspection or the like, the laser irradiation 20 is applied to the CF projecting portion for luminescent spot defect repair 17 at a position opposed to the drain wiring 5 of a pixel having the luminescent spot defect and the CF projecting portion for luminescent spot defect repair 17 at a position opposed to the common wiring 8 from the TFT glass substrate 19 side of the TFT substrate 30.

The insulation film 21 is formed on the drain wiring 5 in an area which overlaps the CF projecting portion for luminescent spot defect repair 17 and this insulation film 21 is destroyed partially by the laser irradiation 20. Consequently, the metal of the drain wiring 5 is melted so as to form the laser irradiated connecting portion 26. As a result, the conductive material of the drain wiring 5 and the conductive film 14 at a front end of the CF projecting portion for luminescent spot repair 17 of the CF substrate 40 are connected to each other by the laser irradiated connecting portion 26 through the destroyed part of the insulation film 21.

On the other hand, no insulation film is formed on a surface of the common wiring 8 side of an area which overlaps the CF projecting portion for luminescent spot defect repair 17 while an oriented film 25 is formed. This oriented film 25 is destroyed partially by the laser irradiation 20. Consequently, the metal of the common wiring 8 is melted so as to form the laser irradiated connecting portion 26. The conductive material of the common wiring 8 and the conductive film 14 at the front end of the CF projecting portion for luminescent spot defect repair 17 of the CF substrate 20 are connected to each other by the laser irradiated connecting portion 26 through the destroyed portion of the oriented film 25. Therefore, the drain wiring 5 and the common wiring 8 are always kept conductive through the conductive film 14 on the CF substrate 40 side, so that the luminescent spot defect portion is turned into black representation thereby to turn the luminescent spot into an unnoticeable black spot defect.

By irradiating one or more positions of the CF projecting portion for luminescent spot defect repair 17 which strides over the drain wiring 5 and the common wiring 8 of a defective pixel with laser beam, the drain wiring 5 and the common wiring 8 can be always kept conductive with each other so as to achieve the unnoticeable black representation (black spot defect).

By turning the spot defect recognized by the representation inspection into the unnoticeable black spot defect without executing any inspection on the state of the TFT substrate 30, the liquid crystal display device 1 in which the yield is further enhanced and the representation quality is enhanced can be obtained without any extra cost.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device in which a liquid crystal is interposed between first and second substrates, wherein
said first substrate is a substrate of an active matrix structure comprising a thin film transistor and
said second substrate is a substrate comprising a color filter, a projecting portion which is disposed in a predetermined area of said color filter and a conductive film formed on a front end of said projecting portion.

2. The liquid crystal display device according to claim 1, wherein said first substrate further comprises a source wiring and a gate wiring each having an insulation film on the surface thereof and
said second substrate has said projecting portion in an area which overlaps opposed said source wiring and gate wiring.

3. The liquid crystal display device according to claim 1, wherein said first substrate further comprises a drain wiring and a common wiring at least one of which has an insulation film on a surface thereof and
said second substrate has said projecting portion in an area which extendedly overlaps opposed said drain wiring and said common wiring.

4. A manufacturing method of a liquid crystal display device comprising the steps of:
(a) preparing a liquid crystal display device in which a liquid crystal is interposed between first and second substrates, wherein
said first substrate is a substrate of an active matrix structure comprising a thin film transistor and
said second substrate is a substrate comprising a color filter, projecting portion which is disposed in a predetermined area of said color filter and a conductive film formed on a front end of said projection portion; and
(b) irradiating said projecting portion with laser beam from a first substrate side of said liquid crystal display device so as to make a wiring on said first substrate and said projecting portion conductive with each other at a position irradiated with said laser beam.

5. The manufacturing method of a liquid crystal display device according to claim 4, wherein
in said liquid crystal display device prepared in the step (a), said first substrate further comprises a source wiring and a gate wiring each having an insulation film on the surface thereof and said second substrate has said projecting portion in an area which overlaps opposed said source wiring and said gate wiring, and
when said source wiring or said gate wiring is broken, the projecting portions between which said broken wiring portion is interposed are irradiated with laser beam in the step (b).

6. The manufacturing method of the liquid crystal display device according to claim 4, wherein
in said liquid crystal display device prepared in said step (a), said first substrate further comprise a drain wiring and a common wiring at least one of which has an insulation film on the surface thereof and said second substrate has said projecting portion in an area which extendedly overlaps opposed said drain wiring and said common wiring, and
when a pixel of said liquid crystal display device is a luminescent spot defect, the projecting portion opposed to said drain wiring and said common wiring of said pixel being said luminescent spot defect is irradiated with laser beam in said step (b).
